(19) United States
(12) Patent Application Publication
(10) Pub. No.: US 2006/0241226 A1
(43) Pub. Date: Oct. 26, 2006

(54) GAP-FILLING CYANOACRYLATE ADHESIVE

(75) Inventors: Thomas Bachon, Duesseldorf (DE); Horst Beck, Neuss (DE); Jennifer Lambertz, Langenfeld (DE); Bernd Beuer, Monheim (DE)

Correspondence Address: HENKEL CORPORATION, THE TRIAD, SUITE 200, 2200 RENAISSANCE BLVD., GULPH MILLS, PA, 19406, US

(73) Assignee: Henkel Kommanditgesellschaft auf Aktien (Henkel KGaA), Duesseldorf (DE)

(21) Appl. No.: 11/427,424

(22) Filed: Jun. 29, 2006

Related U.S. Application Data
(63) Continuation of application No. PCT/EP05/00070, filed on Jan. 7, 2005.

(30) Foreign Application Priority Data
Jan. 9, 2004 (DE) 10 2004 001 493.0

(51) Int. Cl. C08K 5/10

(52) U.S. Cl. 524/315

(57) ABSTRACT

Gap-filling cyanoacrylate adhesives containing cyanoacrylate esters and organic halogenated polymers with a K-value of at least 46.

### CROSS REFERENCE TO RELATED APPLICATIONS

This application is a continuation under 35 U.S.C. § 365(c) and 35 U.S.C. § 120 of international application PCT/EP 2005/000070, filed on Jan. 1, 2005. This application also claims priority under 35 U.S.C. § 119 of DE 10 2004 001 493.0, filed Jan. 9, 2004, which is incorporated herein by reference in its entirety.

### BACKGROUND OF THE INVENTION

The invention relates to a gap-filling cyanoacrylate adhesive. Cyanoacrylate adhesives have basically been known for a long time. Cyanoacrylate adhesives are one-component reactive adhesives based on monomeric esters of 2-cyanoacrylic acid. They have conquered the market by their extremely fast curing, which only requires a few seconds according to the substrate. The resulting properties meet many requirements set forth in industrial practice. Nevertheless they need to be further improved in special cases of application.

In particular, the fact that cyanoacrylate adhesives hitherto could not be applied for making gap-filling bonds, has strongly reduced the field of application of these adhesives which are otherwise very appreciated. Hitherto, cyanoacrylate adhesives could only be applied mainly in cases in which the surfaces of the substrate to be adhered, could essentially be adhered without any gaps.

Compositions are known from the state of the art, which describe the rheological influence of cyanoacrylate esters by addition of ester soluble polymers. Hence, for example, a composition is described in U.S. Pat. No. 4,477,607, which contains a cyanoacrylate ester, a small amount of a dissolved organic polymer and silica gel. The document does not give any indication about the organic polymers used, and their properties with regard to the required molecular weights,

U.S. Pat. No. 3,223,083 relates to the use of cyanoacrylate esters thickened with organic polymers for bonding body tissues, for example for bonding bones. For this purpose, by means of an application exhibiting two chambers, a mixture of one cyanoacrylate ester thickened with an organic polymer on the one hand and a protein dissolved in water on the other hand, are introduced into the area to be adhered.

German Patent DE 34 00 577 C2 relates to cyanoacrylate adhesives which exhibit a relatively small adhesivity to the skin. Suitable cyanoacrylate adhesives for this purpose contain a vinyl chloride/vinyl acetate copolymer, which comprises not less than 5% by weight of vinyl acetate and at the best should have a molecular weight of at least 8,000, there is a problem in the described composition in that the gap-filling properties are only badly developed because of the amount of vinyl acetate. Furthermore, it is shown that resistance to hydrolysis of the thereby obtained bonds leaves much to be desired.

WO 99/28399 relates to a cyanoacrylate adhesive with an ester addition, wherein at least partial and/or complete esters of monovalent or polyvalent aliphatic carboxylic acids are used as esters. The document actually mentions the addition of different polymers; however no indication is given as to their potential for influencing the gap-filling properties.

Accordingly, the object of the present invention consisted in avoiding the drawbacks of the known cyanoacrylate adhesives as regards the lacking gap-filling properties. Specifically, the object according to the invention consisted in preparing a cyanoacrylate adhesive with good storage stability, useful strengths and a practically unchanged setting rate, which additionally is in a position to enable gap-filling bondings and furthermore still exhibits excellent stability to hydrolysis.

### DESCRIPTION OF THE INVENTION

Now, it has been found that adding halogenated polymers with a K value of more than 46 significantly enhances the gap-filling properties of a cyanoacrylate adhesive.

Accordingly, the objects at the basis of the invention are achieved by compositions which contain at least one cyanoacrylate ester and at least one halogen-containing organic polymer with a K value of more than 46.

Accordingly, the object of the present invention is an adhesive, containing at least 50% by weight of a cyanoacrylate ester or a mixture of two or more cyanoacrylate esters and 5 to 15% by weight of at least one halogenated polymer with a K value of at least about 46.

Cyanoacrylate adhesives are essentially based on monoacrylic acid esters and/or bis-cyanoacrylates. By “monocyanoacrylic acid esters”, are meant compounds of general formula I
H₂C═C(CN)—CO—O—R (I)
wherein R represents a C₁-C₂₄ alkyl, alkenyl, C₁-C₂₄ cycloalkyl, aryl, alkoxyalkyl, aralkyl, or haloalkyl, in particular a methyl, ethyl, n-propyl, isopropyl, n-butyl, iso-butyl, pentyl, hexyl, allyl, methallyl, crotyl, propargyl, cyclohexyl, benzyl, phenyl, cresyl, 2-chloroethyl, 3-chloropropyl, 2-chlorobutyl, trifluoroethyl, 2-methoxyethyl, 3-methoxyethyl, and 2-ethoxyethyl.

The aforementioned cyanoacrylates are known to one skilled in the art of adhesives. On this matter, reference is made explicitly to Ullmann's Encyclopaedia of Industrial Chemistry, vol. A1, pp. 240, Verlag Chemie Weinheim (1985) as well as to U.S. Pat. Nos. 3,254,111-A and 3,654,340-A as regards to the corresponding details, wherein the disclosure of the cited documents concerning cyanoacrylate esters and adhesives made therefrom, is understood as being part of the disclosure of the present text.

Preferred monomers are the allyl, methoxyethyl, ethoxyethyl, methyl, ethyl, propyl, isopropyl, or butyl esters of 2-cyanoacrylic acid.

By “biscyanoacrylates” are meant substances of general formula II
[H₂C═C(CN)—CO—O]₂—R¹ (II)
wherein R¹ represents a branched or unbranched, at least bivalent, alkylene with 2 to 18, in particular 6 to 12 C atoms, which may also even contain heteroatoms such as halogens and oxygen, or aliphatic or aromatic rings. However, R¹ preferably represents a pure hydrocarbon.

It is preferred that the biscyanoacrylates be particularly pure for use as part of an adhesive formulation. For example, biscyanoacrylates with suitable purity may be obtained by the following preparation and purification methods: for example, monocyanoacrylates are transesterified with diols and then the reaction mixtures are treated by fractional crystallization.

An appropriate method for making biscyanoacrylates therefore consists of transesterifying 2-cyanoacylic acid or its alkyl ester of general formula III
H₂C═C(CN)—CO—O—R² (III)
wherein R² represents a branched or unbranched alkyl with 1 to 6 C atoms, with diols of general formula IV
[HO]₂—R¹ (IV)
wherein R¹ represents a branched or unbranched bivalent alkylene with 2 to 18 C atoms, which may also even contain heteroatoms such as halogens and oxygen, or aliphatic or aromatic rings, into biscyanoacrylates of general formula II and then purifying the reaction mixture by fractional crystallization.

A starting product is therefore the monofunctional cyanoacrylic acid or its alkyl esters according to formula III. The alkyl should be selected if possible so that the formed alcohol may be removed easily. The possibilities suitable for this are known to one skilled in the art from the general transesterification reaction. Preferably, the alcohol is distilled off. Consequently, R² preferably represents a linear or branched alcohol with 1 to 6 C atoms, preferably with 1 to 2 C atoms. The monofunctional cyanoacrylic acid ester is generally stabilized in the usual way for example.

As for the diols (formula IV), they are bivalent primary or secondary alcohols, preferably primary alcohols. The hydroxyl groups may be positioned essentially in any manner, however they are preferably found at the ends on the hydrocarbon chain. The diols have 2 to 18 C atoms, preferably 6 to 12 C atoms. They may have a linear, branched or cyclic configuration. The aliphatic radical may also contain an aromatic group or even heteroatoms, such as for example chlorine or oxygen atoms, in addition to the hydrogen and carbon atoms, preferably in the form of polyethylene glycol and polypropylene glycol units. Let us mention as specific diols: hexanediol, octanediol, decanediol and dodecanediol.

The cyanoacrylic acid ester is preferably applied in excess. The molar ratio of monofunctional cyanoacrylic acid ester to diol for example, is at least 2.0:1.0, but preferably 2.5:1.0, in particular 2.2:1.0.

Transesterification is catalyzed by strong acids, in particular by sulfonic acids, preferably by aromatic sulfonic acids, such as, for example, p-toluenesulfonic acid. But naphthalenesulfonic acid and benzenesulfonic acid as well as acid ion exchangers are also possible. The concentration of the transesterification catalyst should be between 1 and 20% by weight, based upon the monofunctional cyanoacrylate.

Transesterification preferably occurs in solution. Aromatic substances and halohydrocarbons are used as solvents. The preferred solvents are toluene and xylene. The concentration of the solution is in the range from 10 to 50, preferably from 10 to 20%.

The formed monovalent alcohol or the formed water are removed in a known way, preferably by distillation with the solvent. The yield of the transesterification is controlled by means of NMR spectra for example. The reaction may run over a period of a few minutes to several hours. In the case of toluene as solvent and p-toluenesulfonic acid as catalyst, the reaction is for example completed after 10 to 15 hours, i.e. alcohol is no longer separated.

In the case of acid ion exchangers as catalyst, the latter can simply be filtered out for treating the reaction mixture. In the case of soluble sulfonic acids as catalyst, for example in the case of p-toluenesulfonic acid, the latter is separated by substituting the solvent: toluene is replaced with a mixture of hexane, heptane or decane. Pure biscyanoacrylate is obtained after two fractional crystallizations. Purity according to NMR spectra is higher than 99%.

The obtained biscyanoacrylate is storage-stable with the usual stabilizers and in the usual concentrations, i.e., its melting point does not change at 20° C. within a 6 month period, in practice.

The obtained biscyanoacrylates however polymerize in the presence of bases very rapidly, preferably practically as rapidly as the corresponding monocyanoacrylates. As in the case of monofunctional cyanoacrylates, traces of water are already sufficient. A three-dimensional cross-linked polymer with good thermal properties forms subsequently. An adhesive according to the invention, in addition to a cyanoacrylate ester or a mixture of two or more cyanoacrylate esters, further contains at least one halogen-containing organic polymer.

Examples of such halogen-containing polymers are polymers of vinyl chloride, vinyl resins, which contain vinyl chloride units in the polymer backbone, copolymers of vinyl chloride and esters of acrylic and methacrylic acid or acrylonitrile or mixtures of two or more thereof, copolymers of vinyl chloride with diene compounds or unsaturated dicarboxylic acids or their anhydrides, for example copolymers of vinyl chloride with diethyl maleate, diethyl fumarate, or maleic acid anhydrides, post-chlorinated polymers and copolymers of vinyl chloride, copolymers of vinyl chloride and vinylidene chloride with unsaturated aldehydes, ketones, and other compounds such as acrolein, crotonaldehyde, vinyl methyl ketone, vinyl methyl ether, vinyl isobutyl ether and the like, polymers and copolymers of vinylidene chloride with vinyl chloride and other polymerizable compounds, as those already mentioned above, polymers of vinyl chloroacetate, and dichlorodivinyl ethers, chlorinated polymers of vinyl acetate, chlorinated polymer esters of acrylic acid, and α-substituted acrylic acids, chlorinated polystyrenes, for example polydichlorostyrene, chlorinated polymers of ethylene, polymers and post-chlorinated polymers of chlorobutadiene and their copolymers with vinyl chloride, as well as mixtures of two or more of the cited polymers or polymer mixtures, which contain one or more of the aforementioned polymers.

Within the scope of the present invention, it is required that corresponding halogen-containing polymers have a K value (according to Fikentscher) of at least about 46, preferably of at least about 48. It is more preferred according to the invention that the K value be from about 49 to about 62, in particular from about 50 to about 58.

Further, according to the invention, it is possible to apply a mixture of halogen-containing polymers which have different K values. A mixture of halogen-containing polymers is also suitable, in which the K value above differs by at least about 2, preferably by at least 3 or more, for example by at least about 4, 5, 6, 7 or 8.

Within the scope of a more preferred embodiment of the present invention, an adhesive according to the invention contains as an organic halogen-containing polymer, polyvinyl chloride (PVC) with a K value from about 50 to about 58. Mixtures of polyvinyl chloride with different K values, in particular a mixture of polyvinyl chloride with a K value of about 50 and of a polyvinyl chloride with a K value of about 58, are also suitable.

An adhesive according to the invention contains about 50 to about 99% by weight of cyanoacrylate ester and more than 5% by weight to about 35% by weight of organic halogen-containing polymers, wherein the content of organic halogen-containing polymers with the required K value according to the invention is within the limits mentioned within the scope of the present text.

In addition to the aforementioned components, cyanoacrylate ester and organic halogen-containing polymers, an adhesive according to the invention may additionally contain further additives, for example softeners, thickeners, stabilizers, activators, dyes, and accelerators, for example polyethylene glycol, or cyclodextrin.

Particular ester compounds are suitable as plasticizers. As for the alcohol component of the ester, these are preferably alcohols with 1 to 5, in particular 2 to 4 OH groups and with 2 to 5, in particular 3 or 4 C atoms, directly bound to each other.

The number of C atoms not directly bound to each other may amount to 110, in particular up to 18 C atoms.

As exemplary monovalent alcohols, let us mention: methanol, ethanol, 1-propanol, 2-propanol, 1-butanol, 2-butanol, 2,2-dimethyl-1-propanol, 2-methyl-1-propanol, 2,2-dimethyl-1-propanol, 2-methyl-2-propanol, 2-methyl-1-butanol, 3-methyl-1-butanol, 2-methyl-2-butanol, 3-methyl-2-butanol, 1-pentanol, 2-pentanol, 3-pentanol, cyclopentanol, cyclopentenol, glycidol, tetrahydrofurfurylic alcohol, tetrahydro-2H-pyran-4-ol, 2-methyl-3-buten-2-ol, 3-methyl-2-buten-2-ol, 3-methyl-3-buten-2-ol, 1-cyclopropyl-ethanol, 1-penten-3-ol, 3-penten-2-ol, 4-penten-1-ol, 4-penten-2-ol, 3-pentyn-1-ol, 4-pentyn-1-ol, propargylic alcohol, allylic alcohol, hydroxyacetone, 2-methyl-3-butyn-2-ol.

As exemplary bivalent alcohols, let us mention: 1,2-ethanediol, 1,2-propanediol, 1,3-propanediol, dihydroxyacetone, thioglycerine, 2-methyl-1,3-propanediol, 2-butyne-1,4-diol, 3-butene-1,2-diol, 2,3-butenediol, 1,4-butenediol, 1,3-butenediol, 1,2-butenediol, 2-butene-1,4-diol, 1,2-cyclopentanediol, 3-methyl-1,3-butenediol, 2,2-dimethyl-1,3-propanediol, 4-cyclopentane-1,3-diol, 1,2-cyclopentenediol, 2,2-dimethyl-1,3-propanediol, 1,2-pentenediol, 2,4-pentenediol, 1,5-pentenediol, 4-cyclopentene-1,3-diol, 2-methylene-1,3-propanediol, 2,3-dihydroxy-1,4-dioxane, 2,5-dihydroxy-1,4-dithiane.

As exemplary trivalent alcohols, let us mention: glycerine, erythrulose, 1,2,4-butanetriol, erythrose, threose, trimethylolethane, trimethylolpropane, and 2-hydroxymethyl-1,3-propanediol.

As exemplary quadrivalent alcohols, let us mention: erythritol, threitol, pentaerythritol, arabinose, ribose, xylose, ribulose, xylulose, lyxose, ascorbic acid, gluconic acid γ-lactone.

As exemplary pentavalent alcohols, let us mention: arabitol, adonitol, xylitol.

The polyvalent alcohols described above may also be applied in an ether form for example. The ethers may for example be produced by condensation reactions, Williamson's ether synthesis or by conversion with alkylene oxides such as ethylene oxide, propylene oxide or butylene oxide from the aforementioned alcohols. As examples, let us mention: diethylene glycol, triethylene glycol, polyethylene glycol, diglycerine, triglycerine, tetraglycerine, pentaglycerine, polyglycerine, technical mixtures of condensation products of glycerine, glycerine propoxylate, diglycerine propoxylate, pentaerythritol ethoxylate, dipentaerythritol, ethylene glycol monobutyl ether, propylene glycol monohexyl ether, butyldiglycol, dipropylene glycol monomethyl ether.

As monovalent carboxylic acids for esterification with the aforementioned alcohols, let us mention: formic acid, acrylic acid, acetic acid, propionic acid, butyric acid, isobutyric acid, valeric acid, isovaleric acid, 2-oxovaleric acid, 3-oxovaleric acid, pivalic acid, acetacetic acid, levulic acid, 3-methyl-2-oxobutyric acid, propiolic acid, tetrahydrofurane-2-carboxylic acid, methoxyacetic acid, dimethoxyacetic acid, 2-(2-methoxyethoxy)acetic acid, 2-methylacetic acid, pyruvic acid, 2-methoxyethanol, vinylacetic acid, allylacetic acid, 2-pentenic acid, 3-pentenic acid, tetrahydrofurane-2-carboxylic acid.

As examples of polyvalent carboxylic acids let us mention: oxalic acid, malonic acid, fumaric acid, maleic acid, succinic acid, glutaric acid, acetylene-dicarboxylic acid, oxalacetic acid, acetone-dicarboxylic acid, mesoxalic acid, citraconic acid, dimethylmalonic acid, methylmalonic acid, ethylmalonic acid.

Hydroxycarboxylic acids may also be used as starting materials, for example tartronic acid, lactic acid, malic acid, tartaric acid, citramalic acid, 2-hydroxyvaleric acid, 3-hydroxyvaleric acid, 3-hydroxybutyric acid, 3-hydroxyglucaric acid, dihydroxyfumaric acid, 2,2-dimethyl-3-hydroxypropionic acid, dimethylolpropionic acid, glycolic acid.

Esterification may occur either completely or partially. If necessary, mixtures of these acids may also be used for the esterification.

The esters to be used according to the invention, produced from these alcohols and carboxylic acids or from the corresponding derivatives preferably are free of catalysts, in particular of alkali metals and amines. This can be achieved by treating the esters according to the invention with acids, ion exchangers, acetic aluminas, aluminium oxides, active charcoals, or other adjuvants known to one skilled in the art. For drying them and further purification, they may be distilled.

As exemplary esters particularly suitable as plasticizers, let us mention: ethyl acetate, butyl acetate, glycerine triacetate, glycerine tripropionate, triglycerine pentaacetate, polyglycerine acetate, diethylene glycol diacetate, 3-hydroxyvaleric acid ethyl ester, lactic acid butyl ester, lactic acid isobutyl ester, 3-hydroxybutyric acid ethyl ester, oxalic acid diethyl ester, mesoxalic acid diethyl ester, malic acid dimethyl ester, malic acid diisopropyl ester, tartaric acid diethyl ester, tartaric acid dipropyl ester, tartaric acid diisopropyl ester, glutaric acid dimethyl ester, succinic acid dimethyl ester, succinic acid diethyl ester, malic acid diethyl ester, fumaric acid diethyl ester, malonic acid diethyl ester, acrylic acid 2-hydroxyethyl ester, 3-oxovaleric acid methyl ester, glycerine diacetate, glycerine tributyrate, glycerine tripropionate, glycerine dipropionate, glycerine triisobutyrate, glycerine diisobutyrate, glycidyl butyrate, acetic acid butyl ester, levulic acid ethyl ester, 3-hydroxyglutaric acid dimethyl ester, glycerine acetate dipropionate, glycerine diacetate butyrate, propiolic acid butyl ester, propylene glycol diacetate, propylene glycol dibutyrate, diethylene glycol dibutyrate, trimethylolethane triacetate, trimethylolpropane triacetate, trimethylolethane tributyrate, neopentylic alcohol dibutyrate, methoxyacetic acid pentyl ester, dimethoxy acetic acid butyl ester, glycolic acid butyl ester.

The mentioned esters are added in an amount up to 50% by weight, preferably in an amount from 1 to 30% by weight, based on the total adhesive. The polycyanoacrylates starting from a concentration of 30, in particular 40% by weight, exhibit tacky properties.

Further suitable plasticizers are for example esters such as abietic acid esters, adipic acid esters, azelaic acid esters, benzoic acid esters, butyric acid esters, acetic acid esters, esters of higher fatty acids with about 8 to about 44 C atoms, esters of epoxidized or OH group bearing fatty acids, fatty acid esters and fats, glycolic acid esters, phosphoric acid esters, phthalic acid esters of linear or branched alcohols containing 1 to 12 C atoms, propionic acid esters, sebacic acid esters, sulfonic acid esters, thiobutyric acid esters, trimellitic acid esters, citric acid esters, as well as mixtures of two or more thereof. The asymmetric esters of difunctional, aliphatic or aromatic dicarboxylic acids are particularly suitable, for example the esterification product of adipic acid monooctyl ester with 2-ethylhexanol (Edenol DOA, Cognis, Duesseldorf) or the esterification product of phthalic acid with butanol.

The pure or mixed ethers of monofunctional, linear or branched C₄-C₁₆ alcohols or mixtures of two or more different ethers of such alcohols, for example dioctyl ether (available as Cetiol OE, Cognis, Duesseldort) are also suitable as plasticizers.

Polyethylene glycols with closed terminal groups are also suitably used, for example polyethylene or polypropylene glycol di-(C₁-C₄-alkyl) ethers, in particular dimethyl or diethyl ethers of diethylene glycol or dipropylene glycol, as well as mixtures of two or more thereof.

Basically all materials are suitable as fillers, those which on the one hand fill the adhesive and on the other hand do not adversely influence or no more than is unavoidable, the adhesive properties of the adhesive. Silica gels are particularly suitable as fillers, in particular surface-treated silica gels. For example, suitable fillers are described in U.S. Pat. No. 4,477,607. The disclosure of this document with regards to fillers in adhesives with a content of cyanoacrylate esters is considered as part of the disclosure of the present text.

Further suitable fillers are for example glass powder, glass flour, glass hollow beads or glass fibres as well as other suitable inorganic fillers known to one skilled in the art.

The filler content may basically be selected essentially in any way, as long as the effect according to the invention is not influenced by the filler content. However, filler contents in a range from about 5 to about 30 or about 10 to about 20% by weight, based on the total adhesive, are particularly suitable.

Basically, all compounds currently applied for thickening solutions with a cyanoacrylate ester content may be used as thickeners, as long as they do not adversely influence or no more than is unavoidable, the gap-filling properties of the adhesive according to the invention. The content of an adhesive according to the invention in such thickeners may for example be from 0 to about 10 or from about 2 to about 5% by weight.

Within the scope of the present invention, all compounds applied currently for stabilizing cyanoacrylate esters against radical polymerization are suitable as stabilizers especially radical scavengers based on phenol such as hydroquinone. The content of an adhesive according to the invention in such stabilizers preferably is from about 0 to about 3% by weight, based on the total adhesive.

Within the scope of the present invention, all compounds applied currently for colouring compositions containing cyanoacrylate esters are suitable as dyes, insofar that the latter do not adversely influence or no more than is unavoidable the curing of the adhesive and its gap-filling properties.

In particular, compounds which accelerate the curing of the adhesive without adversely influencing or no more than is unavoidable, its adhesive properties or its gap-filling properties, are suitable as accelerators. The content of an adhesive according to the invention in such accelerators preferably is from about 0 to about 5% by weight, based on the total adhesive.

The adhesive is made as usual by mixing the component. The storage stability of the new adhesives was more than 1 year at room temperature or more than 10 days at 80° C. in all the investigated cases.

The viscosity of an adhesive according to the invention preferably is within a range from about 500 to about 25,000 mPa.s (as measured with a Brookfield RVT, 23° C., spindle 7, 2.5 rpm).

The curing rate is practically uninfluenced by the organic halogen-containing polymers applied according to the invention, i.e., it is preferably not doubled and does not practically exceed 1 min.

The new cyanoacrylate adhesive according to the invention is particularly suitable for bonds especially of rubber, metals, wood, ceramic, china, cardboard, paper, cork, and plastics, except PE, PP and Teflon and Styropore.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

The invention is now explained in detail with the help of examples:

### EXAMPLES

In order to obtain an overview as complete as possible, on the properties of the adhesives according to the invention, mixtures of basically stabilized pure esters and different polymers were made. Further, ethyl cyanoacrylate was heated to 80° C. with moisture excluded and mixed with different organic polymers. The polymers were dissolved or gelified for 10-20 minutes at 80-100° C.

PVC-PVC bonds with a gap (0.6 mm) or without any gap, were made with the cyanoacrylate polymer mixtures. The combined tension and shear resistances were determined after 7 days of storage.

In addition, wood-wood bonds with a gap (0.4 mm) and without any gap, were made with the cyanoacrylate polymer mixtures. The bonds were stored for 24 h, and then boiled for 6 h in water, and the combined tension and shear resistances were determined after further 2 h storage in cold water.

The results are summarized in the following table:

| | | PVC | PVC | Wood | Wood |
|---|---|---|---|---|---|
| | | (0 mm) | (0.6 mm) | (0 mm) | (0.6 mm) |
| N°: | Mixture; | (N/mm²) | (N/mm²) | (N/mm²) | (N/mm²) |
| 1 | Ethyl CA | 6.5 | 0 | 6.8* | 0 |
| 2 | Ethyl CA + PVAc | 6.6 | 2.6 | 7.8 | 0 |
| | (9%) | | | | |
| 3 | Ethyl CA + PVC(K | 14.2 | 4.4 | 8.0 | 4.4 |
| | value = 50) (9%) | | | | |
| 4 | Ethyl CA + PVC(K | 7.1 | 3.4 | 7.5 | 4.1 |
| | value = 50) | | | | |
| | (4.5%) + PVC (K | | | | |
| | value = 58) (4.5%) | | | | |
| 5 | Ethyl CA + PVC(K | 10.5 | 8.9 | 7.1 | 2.7 |
| | value = 58) (9%) | | | | |

Conclusions/Explanations

Pure CA does not have any gap-filling properties (Example 1).

CA is thickened by PVAC and delivers moderately good resistances, but is rapidly hydrolyzed in the gap (Example 2).

PVC interacts with CA by filling the gap and even after treatment with boiling water provides sufficient resistances.

Making of an Adhesive Formulation

75 g of ethyl cyanoacrylate were mixed with 15 g of PVC powder (K value=50) and heated without stirring with air excluded. The warm mixture was stirred for 10 minutes with air excluded and then mixed with 2 g of hydrophobicized silicic acid and further stirred for 5 minutes.

Wood-wood bonds were made with the adhesive and the following properties were determined.

| | | | |
|---|---|---|---|
| Heat resistance Watt 91 at 80° C. | 10.55 | N/mm² | 100% HB |
| Dry adhesivity EN 204 D1 | 12.08 | N/mm² | 100% HB |
| Wet adhesivity EN 204 D3 | 7.52 | N/m² | 100% HB |
| Wet adhesivity EN 204 D4 | 6.37 | N/mm² | KB |

Various substrates were adhered together with the adhesive and the combined tension and shear resistances were determined after 2 days of storage:

| | |
|---|---|
| PVC—PVC | 7.1 N/mm² |
| Birch wood-birch wood | 7.5 N/mm² |
| PMMA—PMMA | 5.5 N/mm² |
| Aluminium-aluminium | 4.6 N/mm² |
| Brass-brass | 6.0 N/mm² |

PVC tubes were adhered with the adhesive by means of a fitting et service life investigations were performed at room temperature and at a hydrostatic pressure of 50 bars. The adhesives outlasted the test period of more than 1,000 hours, undamaged.

What is claimed is:

1. An adhesive, comprising at least 50 weight % of one or more cyanoacrylate esters and 5 to 15 weight % of at least one halogenated polymer having a K-value of at least about 46.

2. The adhesive of claim 1, comprising 60 to 95 weight % of the one or more cyanoacrylate esters.

3. The adhesive of claim 2, comprising 7 to 12 weight % of at least one halogenated polymer with a K-value of at least about 46.

4. The adhesive of claim 3, comprising at least one organic halogen-containing polymer with a K-value of at least 50.

5. The adhesive of claim 4, comprising at least one organic halogen-containing polymer with a K-value of maximum 58.

6. The adhesive of claim 1, comprising a filler.

7. The adhesive of claim 1, wherein the cyanoacrylate esters comprise one or more of ethyl cyanoacrylate, butyl cyanoacrylate or methoxyethyl cyanoacrylate.

8. The adhesive of claim 1, comprising 7 to 12 weight % of at least one halogenated polymer with a K-value of at least about 46.

9. The adhesive of claim 1, comprising at least one organic halogen-containing polymer with a K-value of at least 50.

10. The adhesive of claim 2, comprising at least one organic halogen-containing polymer with a K-value of at least 50.

11. The adhesive of claim 1, comprising at least one organic halogen-containing polymer with a K-value of maximum 58.

12. The adhesive of claim 2, comprising at least one organic halogen-containing polymer with a K-value of maximum 58.

13. The adhesive of claim 3, comprising at least one organic halogen-containing polymer with a K-value of maximum 58.

14. The adhesive of claim 2, wherein the cyanoacrylate esters comprise one or more of ethyl cyanoacrylate, butyl cyanoacrylate or methoxyethyl cyanoacrylate.

15. The adhesive of claim 3, wherein the cyanoacrylate esters comprise one or more of ethyl cyanoacrylate, butyl cyanoacrylate or methoxyethyl cyanoacrylate.

16. The adhesive of claim 4, wherein the cyanoacrylate esters comprise one or more of ethyl cyanoacrylate, butyl cyanoacrylate or methoxyethyl cyanoacrylate.

17. The adhesive of claim 5, wherein the cyanoacrylate esters comprise one or more of ethyl cyanoacrylate, butyl cyanoacrylate or methoxyethyl cyanoacrylate.
